(19) United States
(12) Patent Application Publication
(10) Pub. No.: US 2014/0054144 A1
(43) Pub. Date: Feb. 27, 2014

(54) CARBON NANOTUBE TOUCH PANEL AND METHOD FOR MAKING SAME

(71) Applicant: TIANJIN FUNAYUANCHUANG TECHNOLOGY CO., LTD., Tianjin (CN)

(72) Inventor: HO-CHIEN WU, New Taipei (TW)

(73) Assignee: TIANJIN FUNAYUANCHUANG TECHNOLOGY CO.,LTD., Tianjin (CN)

(21) Appl. No.: 13/972,950

(22) Filed: Aug. 22, 2013

(30) Foreign Application Priority Data
Aug. 24, 2012 (CN) 2012103046718

(51) Int. Cl. H01H 1/027

(52) U.S. Cl. CPC H01H 1/027
USPC 200/267; 156/229

(57) ABSTRACT

A method for making a carbon nanotube (CNT) touch panel includes forming a first CNT film and a second CNT film where the first CNT film and the second CNT film are adhered onto a same surface of a base.

### CROSS-REFERENCE TO RELATED APPLICATIONS

This application claims all benefits accruing under 35 U.S.C. §119 from China Patent Application No. CN201210304671.8, filed on Aug. 24, 2012, in the China Intellectual Property Office, the disclosure of which is incorporated herein by reference in its entirety. This application is related to commonly-assigned applications entitled, “CARBON NANOTUBE TOUCH PANEL AND TOUCH DISPLAY APPARATUS USING SAME” filed ______ (Atty. Docket No. US46684), “CARBON NANOTUBE TOUCH PANEL HAVING TWO CARBON NANOTUBE FILMS” filed ______ (Atty. Docket No. US46691), “CARBON NANOTUBE TOUCH PANEL HAVING AT LEAST TWO CARBON NANOTUBE FILMS” filed ______ (Atty. Docket No. US46692), “CARBON NANOTUBE TOUCH PANEL AND TOUCH DISPLAY APPARATUS USING SAME” filed ______ (Atty. Docket No. US46694), “TOUCH PANEL AND TOUCH DISPLAY APPARATUS USING SAME” filed ______ (Atty. Docket No. US46695), and “TOUCH PANEL AND TOUCH DISPLAY APPARATUS USING SAME” filed ______ (Atty. Docket No. US46960).

### BACKGROUND

1. Technical Field

The present disclosure relates to touch sensing technologies, particularly to a large-area carbon nanotube (CNT) touch panel and a method for making the CNT touch panel.

2. Description of Related Art

Carbon nanotube (CNT) touch panels are used in touch display apparatus because the CNT touch panels are durable. A typical CNT touch panel includes a single CNT film formed on a substrate, the CNT film includes a plurality of CNTs arranged in parallel. However, conductivity of the CNT decreases as a length of the CNT increases. This characteristic is a limit in design, and making a CNT touch panel with a large size is problematic.

What is needed is to provide a means that can overcome the above-described limitations.

### BRIEF DESCRIPTION OF THE DRAWINGS

Many aspects of the embodiments can be better understood with reference to the following drawings. The components in the drawings are not necessarily drawn to scale, the emphasis instead being positioned upon clearly illustrating the principles of the embodiments. Moreover, in the drawings, like reference numerals designate corresponding parts throughout the several views.

FIG. 1 is a schematic view of a CNT touch panel according to an embodiment of the present disclosure.

FIG. 2 is a schematic view of a CNT film of the CNT touch panel of FIG. 1.

FIG. 3 is a schematic view of an alternative CNT touch panel according to an embodiment of the present disclosure.

FIG. 4 is a schematic view of another alternative CNT touch panel according to an embodiment of the present disclosure.

FIG. 5 a flow chart of a method for making a CNT touch panel according to an embodiment of the present disclosure.

FIG. 6 is a flow chart of forming a first CNT film and a second CNT film in the method of FIG. 5.

FIG. 7 is a flow chart of disposing the first CNT film and the second CNT film on a base in the method of FIG. 5.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

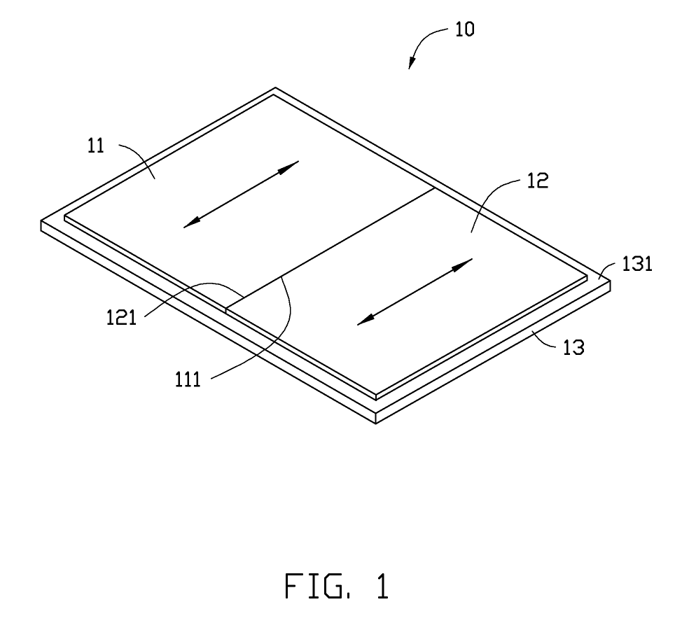

FIG. 1 shows a CNT touch panel 10 according to an embodiment of the present disclosure. The CNT touch panel 10 includes a first CNT film 11, a second CNT film 12, and a base 13. The base 13 may be a transparent glass or a plastic substrate, which includes a top surface 131. The first CNT film 11 and the second CNT film 12 are positioned in parallel on the top surface 131 of the base 13, and the first CNT film 11 and the second CNT film 12 are attached to a same surface of the base 13 such that the first CNT film 11 and the second CNT film 12 are substantially located in a same plane.

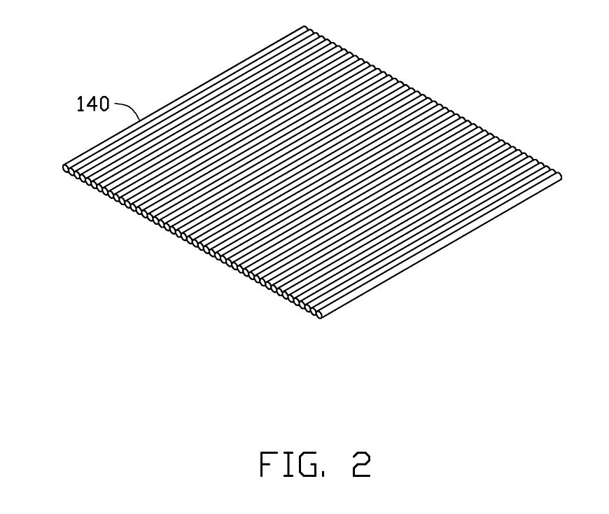

The first CNT film 11 and the second CNT film may have a same configuration, for example. FIG. 2 shows that each of the first CNT film 11 and the second CNT film 12 includes a plurality of CNTs 140. The CNTs 140 are arranged parallel to each other, and are joined end to end therebetween by van der Waals force. To simplify the description, the CNTs 140 in the first CNT film 11 are named as first CNTs, and CNTs 140 in the second CNT films 12 are named as second CNTs.

The first CNTs in the first CNT film 11 have a same orientation as the second CNTs in the second CNT film 12; in some embodiment, the first CNTs in the first CNT film 11 may have an orientation perpendicular to the second CNTs in the second CNT film 12. Moreover, each of the first CNTs in the first CNT film 11 and the second CNTs in the second CNT film 12 may be a single-walled nanotubes (SWNTs) with a diameter of 0.5 to 50 nanometers, or a double-walled nanotubes (DWNTs) with a diameter of 1.0 to 50 nanometers, or a multi-walled nanotubes (MWNTs) with a diameter of 1.5 to 50 nanometers.

The first CNT film 11 and the second CNT film 12 are both rectangle-shaped films with a same size (or at least with a same length in the orientation of the CNTs 140). The first CNT film 11 includes a first edge 111 parallel to the orientation of the CNTs 140 in the first CNT film 11. The second CNT film 12 includes a second edge 121 parallel to the orientation of the CNTs 140 in the second CNT film 12. The first edge 111 of the first CNT film 11 is adjacent to and aligned with the second edge 121 of the second CNT film 12, for example, in the present embodiment, the first edge 111 of the first CNT film 11 may abut the second edge 121 of the second CNT film 12, such that the first CNT 11 and the second CNT film 12 cooperatively form a large-area rectangular CNT layer.

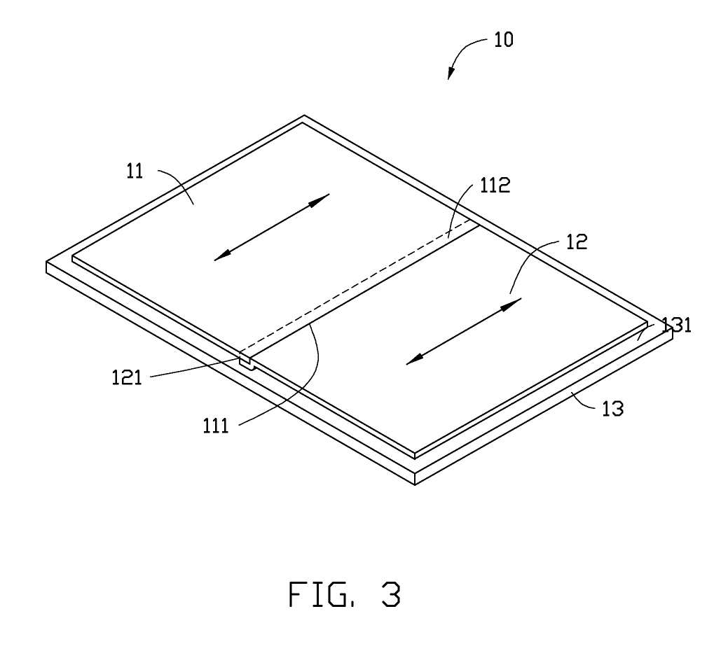

FIG. 3 shows that in an alternative embodiment, the first edge 111 of the first CNT film 11 may partly overlap the second edge 121 of the second CNT film 12 to form an overlapping region 112. The overlapping region 112 is also in a shape of rectangle, and in particular, a width of the overlapping region 112 is less than 2 millimeters.

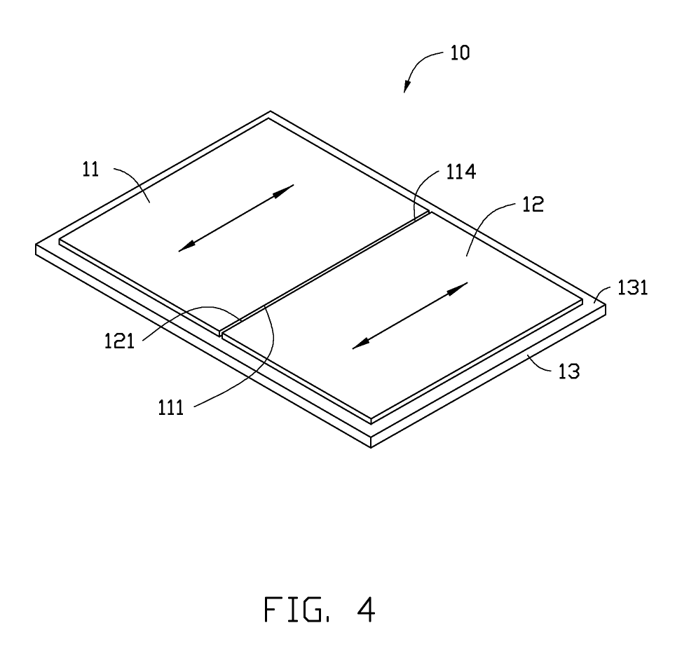

FIG. 4 shows that in another alternative embodiment, the first edge 111 of the first CNT film 11 is separated from the second edge 121 of the second CNT film 12, and thereby a gap region 114 is formed between the first CNT film 11 and the second CNT film. The gap region 114 is also in a shape of rectangle, and in particular, a width of the gap region 114 is less than 5 millimeters.

In the foregoing CNT touch panel 10, the first CNT film 11 and the second CNT film 12 are positioned in parallel on the base 13, the first CNT film 11 and the second CNT film 12 cooperatively form a large size CNT layer without the need of growing or creating long CNTs. As such, the CNT touch panel 10 may be made with a large area.

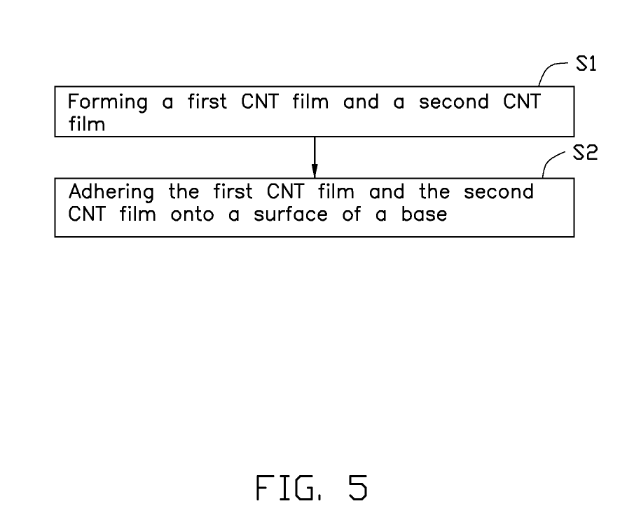

FIG. 5 shows a method for making the CNT touch panel 10 according to one embodiment of the present disclosure. The method comprises: step S1, forming a first CNT film 11 and a second CNT film 12; and step S2, adhering the first CNT film 11 and the second CNT film 12 onto a base 13.

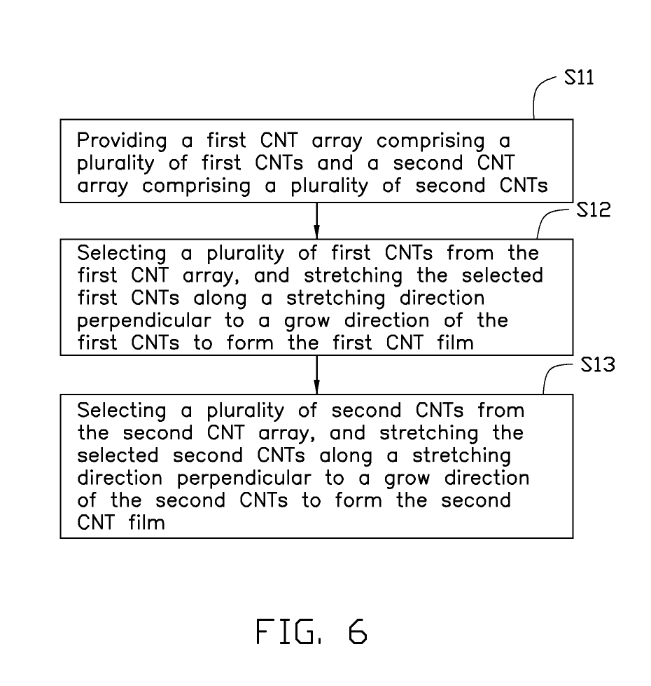

In step S1, the first CNT film 11 and the second CNT film 12 may be formed by a film stretching method. FIG. 6 shows that the film stretching method for forming the first CNT film 11 and the second CNT film 12 may include the following sub-steps.

Sub-step S11, a first CNT array comprising a plurality of first CNTs and a second CNT array comprising a plurality of second CNTs are provided.

For example, the first CNT array and the second CNT array may both be super-aligned CNT arrays, the super-aligned CNT arrays may be obtained through chemical vapor deposition (CVD), arc discharge by using graphite electrode in a constant-current mode, or laser ablation. Each of the first CNT array and the second CNT array may be an SWNT array, a DWNT array or a MWNT array. Te first CNT array includes a plurality of first CNTs which are parallel to each other and grow vertically from a first substrate, and the second CNT array includes a plurality of second CNTs which are parallel to each other and are grown vertically from a second substrate. Both of the first substrate and the second substrate are recyclable, and an area of the first substrate for growing the first CNTs is substantially equal to that of the second substrate for growing the second CNTs. The first CNT array and the second CNT array may both have a height greater than 100 micrometers.

Sub-step S12, a plurality of first CNTs are selected from the first CNT array, and the selected first CNTs are stretched along a stretching direction perpendicular to a growing direction of the first CNTs to form the first CNT film.

Sub-step S13, a plurality of second CNTs are selected from the second CNT array, and the selected second CNTs are stretched along a stretching direction perpendicular to a growing direction of the second CNTs to form the second CNT film.

In sub-step S12, while the selected first CNTs gradually separates from the first substrate along the stretching direction under the stretching force, other first CNTs are successively drawn out under the van der Waals force, thus forming a successive and uniform first CNT film 11 having a preferred width and orientation. Similarly, in sub-steps S13, while the selected second CNTs gradually separates from the second substrate along the stretching direction under the stretching force, other second CNTs are also successively drawn out under the van der Waals force, thus forming a successive and uniform second CNT film 12 having a preferred width and orientation.

In some embodiments, the film stretching method may further include other post-treatment sub-step. For example, after the first CNT film 11 and the second CNT film 12 are formed, a laser treatment may be performed on the first CNT film 11 and the second CNT film 12 to remove CNT bundles in the first CNT film 11 and the second CNT film 12.

Due to the van der Waals force, some of the first CNTs or the second CNTs may be accumulated into CNT bundles, the CNT bundles normally have such a great diameter that light transmissibility of the CNT film. In the present embodiment, laser treatment may be performed to remove the CNT bundles. For example, laser equipment providing a laser light with a power density greater than 0.1*104 watts per square meter may be used to irradiate the first CNT film 11 and the second CNT film 12 in an aerobic environment, when the laser light irradiates the CNT bundles, the CNT bundles are eliminated from the first CNT film 11 and the second CNT film 12, and thus the light transmissibility of the first CNT film 11 and the second CNT film 12 is improved.

In other embodiments, the first CNT film 11 and the second CNT film 12 may alternatively formed by use of other method, such as a growing method, a rolling compaction method, or a flocculation method.

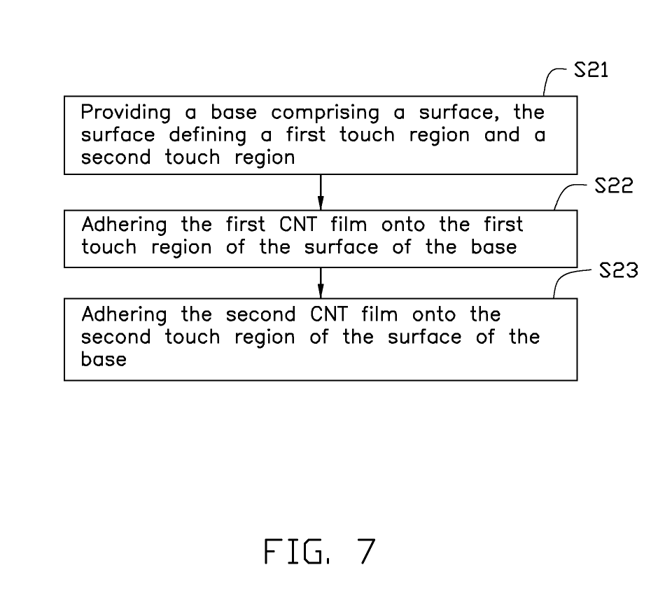

FIG. 7 shows that in step S2, the first CNT film 11 and the second CNT film 12 may be adhered onto the base 13 by the following sub-steps.

Sub-step S21, a base 13 including a surface 131 defining a first touch region and a second touch region is provided.

The base 13 may be a transparent glass or a plastic substrate, and the surface 131 may be a top surface of the base 13. The top surface 131 of the base 13 may define a first touch region and a second touch region, the first touch region and the second touch region are parallel to each other, and respectively have shapes and sizes matching the first CNT film 11 and the second CNT film 12.

Sub-step S22, the first CNT film 11 is adhered onto the first touch region of the surface 131 of the base 13.

Sub-step S23, the second CNT film 12 is adhered onto the second touch region of the surface 131 of the base 13.

In sub-steps S21 and S22, the first CNT film 11 and the second CNT film 12 may be respectively adhered to the first touch region and the second touch region through self-viscosity, or by using an adhesive, or a heat-pressing treatment. Since the first touch region and the second touch region are parallel to each other, after being adhered onto the base 13, the first CNT film 11 is parallel to the second CNT film 12.

In one embodiment, the first touch region borders on the second touch region, and thus a first edge 111 of the first CNT film 11 abuts a second edge 112 of the second film 12, as shown in FIG. 1.

In an alternative embodiment, the first touch region partly overlaps the second touch region, and thus the first edge 111 of the first CNT film 11 partly overlap the second CNT film 12 to form an overlapping region 112, as shown in FIG. 3.

In another alternatively embodiment, the first touch region is apart from the second touch region, and thus the first CNT film 11 is separated from the second CNT film 12 to form a gap region 113, as shown in FIG. 5.

Depending on the embodiment, certain steps of methods described may be removed, others may be added, and the sequence of steps may be altered. It is also to be understood that the description and the claims drawn to a method may include some indication in reference to certain steps. However, the indication used is only to be viewed for identification purposes and not as a suggestion as to an order for the steps.

It is to be understood that the described embodiments are intended to illustrate rather than limit the disclosure. Any elements described in accordance with any embodiments is understood that they can be used in addition or substituted in other embodiments. Embodiments can also be used together. Variations may be made to the embodiments without departing from the spirit of the disclosure. The disclosure illustrates but does not restrict the scope of the disclosure.

What is claimed is:

1. A carbon nanotube (CNT) touch panel, comprising:
a base;
a first CNT film; and
a second CNT film;
wherein the first CNT film and the second CNT film are attached to a same surface of the base such that the first CNT film and the second CNT film are substantially located in a same plane.

2. The CNT touch panel of claim 1, wherein the first CNT film comprises a plurality of first CNTs arranged parallel to each other, and the second CNT film comprises a plurality of second CNTs arranged parallel to each other.

3. The CNT touch panel of claim 2, wherein the first CNTs in the first CNT film have a same orientation as orientation of the second CNTs in the second CNT film.

4. The CNT touch panel of claim 2, wherein the first CNTs in the first CNT film have an orientation perpendicular to orientation of the second CNTs in the second CNT film.

5. The CNT touch panel of claim 1, wherein the first CNT film comprises a first edge, and the second CNT film comprises a second edge, the first edge of the first CNT film is adjacent to and aligned with the second edge of the second CNT film.

6. The CNT touch panel of claim 5, wherein the first edge of the first CNT film abuts the second edge of the second CNT film.

7. The CNT touch panel of claim 5, wherein the first edge of the first CNT film partially overlaps the second edge of the second CNT film to form an overlapping region therebetween.

8. The CNT touch panel of claim 5, wherein the first edge of the first CNT film is separated from the second edge of the second CNT film to form a gap region therebetween.

9. A method for making a carbon nanotube (CNT) touch panel, comprising:
forming a first CNT film and a second CNT film; and
adhering the first CNT film and the second CNT film onto a same surface of a base.

10. The method of claim 9, wherein the first CNT film and the second CNT film are formed by a film stretching method.

11. The method of claim 10, wherein the film stretching method comprises:
providing a first CNT array comprising a plurality of first CNTs and a second CNT array comprising a plurality of second CNTs;
selecting a plurality of first CNTs from the first CNT array, and stretching the selected first CNTs along a stretching direction perpendicular to a grow direction of the first CNTs to form the first CNT film; and
selecting a plurality of second CNTs from the second CNT array, and stretching the selected second CNTs along a stretching direction perpendicular to a grow direction of the second CNTs to form the second CNT film.

12. The method of claim 11, wherein the first CNT array and the second CNT array are obtained through chemical vapor deposition (CVD), arc discharge by using graphite electrode in a constant-current mode, or laser ablation.

13. The method of claim 11, wherein the first CNTs are grown vertically from a first substrate, and the second CNTs are grown vertically from a second substrate, wherein both of the first substrate and the second substrate are recyclable.

14. The method of claim 11, wherein the film stretching method further comprises:
performing a laser treatment on the first CNT film and the second CNT film to remove CNT bundles in the first CNT film and the second CNT film.

15. The method of claim 9, wherein the first CNT film and the second CNT film are formed through a growing method, a rolling compaction method, or a flocculation method.

16. The method of claim 9, wherein the adhering the first CNT film and the second CNT film onto the surface of the base comprises:
providing a base comprising a surface, the surface defining a first touch region and a second touch region;
adhering the first CNT film onto the first touch region of the surface of the base; and
adhering the second CNT film onto the second touch region of the surface of the base.

17. The method of claim 16, wherein the first CNT film and the second CNT film are respectively adhered to the first touch region and the second touch region through self-viscosity thereof, or by using an adhesive, or by a heat-pressing treatment.

18. The method of claim 16, wherein the first touch region borders on the second touch region, and a first edge of the first CNT film abuts a second edge of the second film.

19. The method of claim 16, wherein the first touch region partially overlaps the second touch region; and an first edge of the first CNT film partly overlap a second CNT film to form an overlapping region.

20. The method of claim 16, wherein the first touch region is apart from the second touch region, and the first CNT film is separated from the second CNT film to form a gap region.
